(19) United States
(12) Patent Application Publication
(10) Pub. No.: US 2007/0088893 A1
(43) Pub. Date: Apr. 19, 2007

(54) System and Method for Installing Hardware Device Drivers for Network Devices on Systems Limited to Single Computer Plug-and-Play Logic

(75) Inventor: Jason Carnahan, Boise, ID (US)

Correspondence Address: ROBERT A. HUNTSMAN, 5465 EAST TERRA LINDA WAY, NAMPA, ID, 83687-1515, US

(73) Assignee: KESTRELINK CORPORATION, Boise, ID (US)

(21) Appl. No.: 11/163,423

(22) Filed: Oct. 18, 2005

(51) Int. Cl. G06F 13/00; G06F 9/46

(52) U.S. Cl. 710/302; 719/321

(57) ABSTRACT

A system and method for orderly installing hardware devices and associated software drivers in a networked environment on client computers having only local plug-and-play installers. The preferred embodiment teaches the use of a web browser, web server, and network access point device to mount and manage the installation of various hardware devices for use by selected computers participating in the associated local network.

Modern computing systems, such as those found in offices, schools, and homes, often consist of a number of discreet computers logically connected by a network. Modern discrete computers are often based on a popular operating systems such as Microsoft Windows or Linux. Unlike operating systems of previous generations, modern operating systems strive to be consumer friendly and attempt to allow computer novices to successfully perform essential computer related tasks. In particular, most modern operating systems include a plug-and-play installer that allows consumers, computer novices as well as the computer literate, to easily install new hardware devices. In older computers, new hardware was frequently installed by removing the cover of the computer inserting an electronics card into the backplane of the motherboard of the computer. The newest trend involves the implementation of the universal serial bus (USB) where multiple devices can be plugged into the computer with a simple connector, obviating the need to remove the cover of the computer and handle electronic computer cards. Whether devices are installed directly into the backplane of the motherboard or whether they are plugged into a USB port, operating system software corresponding to the hardware device generally called a device driver needs to be installed on the host computer and essential serves as an interface between the hardware device and the operating system. For example, when a printer is added to a computer system, the presence of the appropriate software driver causes the name of the printer to appear in printer selection menus in application programs, and performs necessary data transformations, converting print data from an application program to whatever format is required by the particular printer. In order to automate the process, in a plug-and-play system there is some kind of hardware bus driver (backplane bus driver or USB bus driver in the example previously described), that can recognize when a new device is present and trigger the plug-and-play installer of the computer to locate and load the appropriate software driver. Typically the newly attached device will communicate to the associated bus a device identifier that the play-and-play installer then can use to locate the needed corresponding driver.

Plug-and-play systems are well established for single discrete computers and for installing hardware devices on single discrete computers. However, many modern computers are on networks, and it is often very desirable to install hardware devices on the network in some fashion for general shared usage amongst the participating computers on the network. Traditional plug-and-play installers do not work for these network devices because the prior art systems depend on the devices being physically installed on the particular computer to trigger the plug-and-play installer logic. In a network scenario, devices plugged in elsewhere on the network are connected indirectly to each computer only through the network rather than through any kind of direct bus connection.

To address the problem of universally connecting hardware devices through a network rather than directly connected such devices to a particular computer, a new specification known as “universal plug-and-play” has been proposed and has been implemented by some manufacturers. Unfortunately, universal plug-and-play is a new and relatively complex specification, not backwards compatible with the well known traditional local play-and-play installers. Special coding in both new hardware devices and the operating systems is required before universal plug-and-play will be widely adopted. While such a system may eventually predominate the computer marketplace if and when the specification is universally adopted and implemented by all manufacturers, it is overkill for many simple network devices and is not present of in many of the popular, older versions of operating systems.

What is needed is a simple network friendly plug-and-play systems that can provide for consumer friendly hardware device installation in both older computing environments as well as in newer systems the state-of-the-art operating systems.

### BRIEF SUMMARY OF THE INVENTION

The present invention overcomes the limitations of the prior art by introducing the novelty of a network-aware virtual bus driver that both interfaces with older single computer plug-and play installers and a computer network having attached network devices. The virtual bus driver is aware of network hardware devices, but presents such devices to the local plug-and-play installer by making them appear that distance devices on the network are actually local. In the preferred embodiment, a network access point device is taught, providing a place for hardware devices to be connected to the network without being connected to a particular computer. In the preferred embodiment, web browser and web server technology is utilized to both locate and configure network devices of interest.

### BRIEF DESCRIPTION OF THE SEVERAL VIEWS OF THE INVENTION

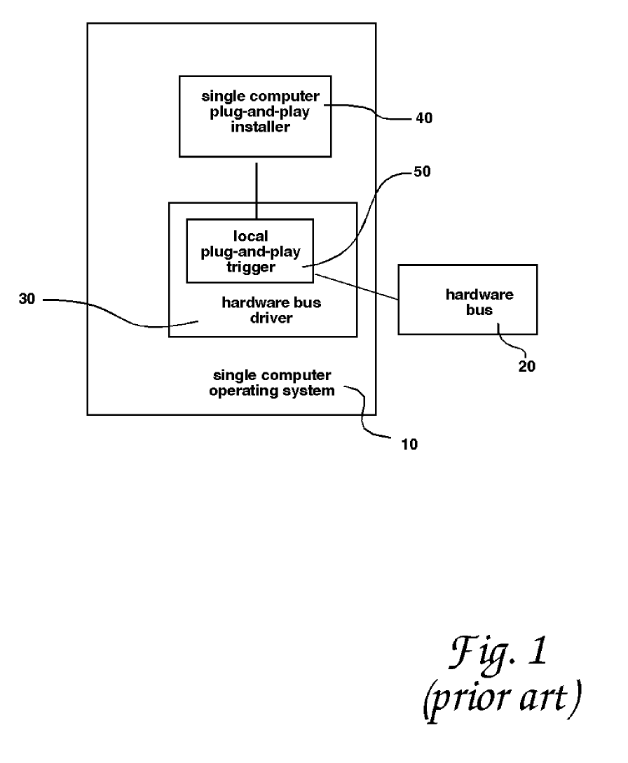

FIG. 1 illustrates generally the relationship of plug-and-play logic, a hardware bus, and a single computer operating system according to the prior art.

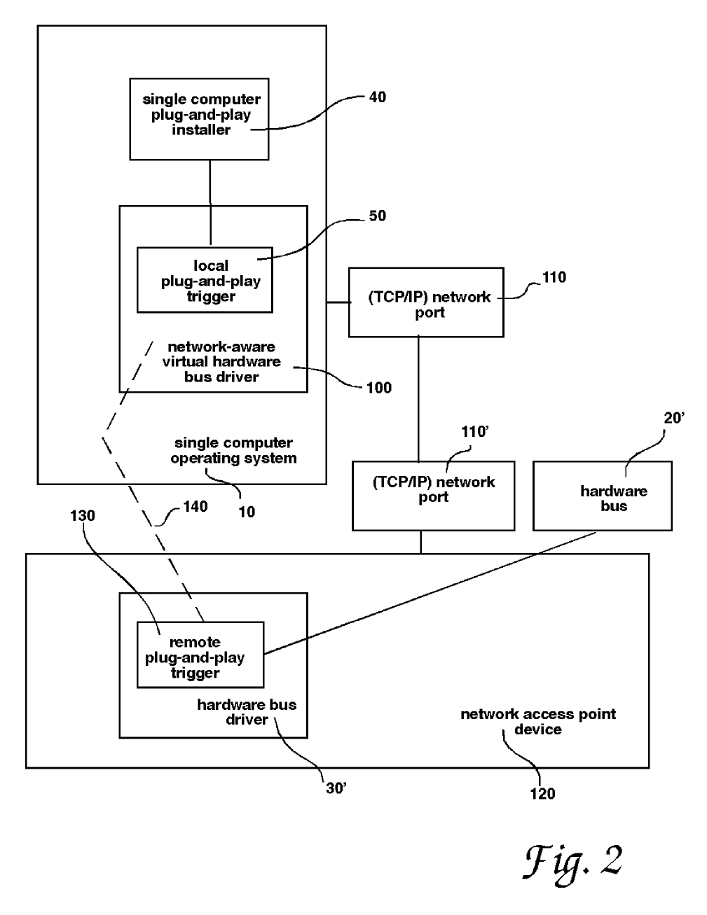

FIG. 2 illustrates generally the relationship of plug-and-play logic, a network-aware virtual bus driver, a network access point device, a hardware bus, and a single computer operating system according to the preferred embodiment of the present invention.

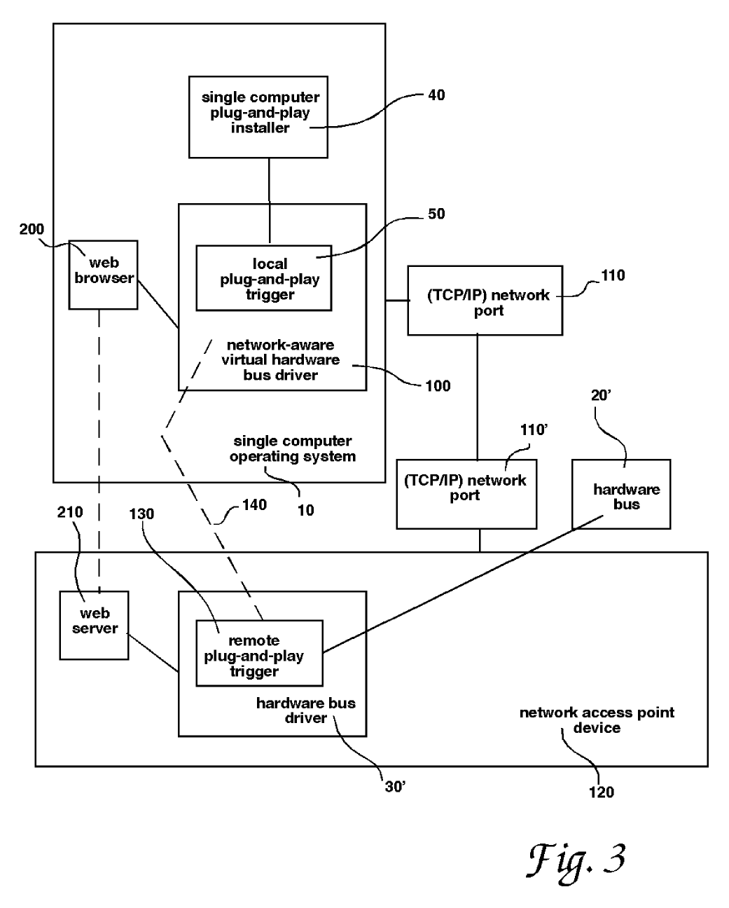

FIG. 3 illustrates generally the relationship of a web browser, a web server, plug-and-play logic, a network-aware virtual bus driver, a network access point device a hardware bus, and a single computer operating system according to the preferred embodiment of the present invention.

### DETAILED DESCRIPTION OF THE INVENTION

FIG. 1 generally illustrates the major components of a very popular (and widely adopted) prior-art plug-and-play system and services as a useful basis for understanding the present invention. Referring to FIG. 1, FIG. 1 shows a single computer operating system 10, such as Microsoft Windows, or Linux. Such operating systems are frequently found in computers (not shown) that have one or more hardware busses 20 such as a universal serial bus (USB) or backplane hardware bus. Each such bus 20 has an associated hardware bus driver 30 that is able to detect devices attached to the associated hardware bus 20. The presence of a new device on a hardware bus 20 typically causes the local plug-and-play trigger 50 to logically “fire” and notify the single plug-and-play installer 40 of the presence of the new device. An identifier associated with the device is generally passed by the device to the hardware bus driver 30 that in turn passes the identifier to the plug-and-play installer 40. The plug-and-play installer 40 generally will looks a number places, including the local computer, a manufacturer's media, the internet, or, optionally, prompting the use to help locate the required driver. Upon locating a suitable driver, the single computer plug-and-play installer loads the driver and performs whatever additional steps required by the underlying operating system 10 to enable the driver and the associated device connected to the hardware bus 20 to function.

FIG. 2 shows an embodiment of the present invention. Referring to FIG. 2, the computer hosting the single computer operating system 10 and the hardware bus 20′ are not directly connected to each other, but are on different nodes on a computer network and are only indirectly connected via a common computer network via the network ports 110 and 110′. In this embodiment, the hardware bus 20′ is included in a network access point device 120, which contains its own hardware bus driver 30′, and also included a remote plug-and-play trigger 130 capable of firing either because of some external event or because of a presence of a new device present on the hardware bus driver 30′. The remote plug-and-play trigger 130 communicates with the network-aware virtual bus driver 100 through a logic channel represented by the dotted line 140 in FIG. 2. The actual physical communication takes place through the network represented by the network ports 110 and 110′. In this embodiment, the remote plug-and-play trigger 130 could be triggered by a number of events, including, but not limited to the attachment of a new device to the hardware bus 20′.

As a practical matter, in a general network, there are multiple computers having single computer operating systems 10, and it generally not desirable to have drivers installed on each and every computer on the network automatically when a new hardware device is installed somewhere on the network. To address the need to manage the connection between new devices on the network and the various computers, the preferred embodiment refrains from automatically firing when the hardware device 30′ detects a new device and instead teaches the addition of a web client and web server to assist in an orderly connection of new devices. Referring to FIG. 3, FIG. 3 is similar to the embodiment of FIG. 2 except it includes a web browser 200 on each computer hosting the operating system 10 on the network and a web server 210 within a network access point device 120 capable of display devices of interest on hardware bus 20. when invoked by a particular web browser 200. The web server 210 is typically configured to have a known local network address which a user deploying a web browser 200 uses to manage the installation process. When the web server 210 receives an appropriate request from a web browser 200, it typically displays a list of candidate devices, configurable devices options, and a web means to select and configure various devices and options, thus limiting the installation of device drivers to those computers who specifically request them.

The present invention is not limited to any particular operating system, any particular network topology, or any specific plug-and-play system. As one skilled in the art will appreciate, variations in the details do not detract from the many applications of the invention. The descriptions above are provided to illustrate two embodiments, but the present invention may be manifest in many embodiments not shown. Accordingly, the illustrations above are provided for description and illustration, but not for limitation. The invention should be limited only by the claims as set forth below.

What is claimed is:

1. A system for installing a software driver for a hardware device in a client computer in a networked environment, wherein the client computer is interfaced to the networked environment, the client computer further includes an operating system, the operating system further includes a local plug-and-play installer capable of installing software drivers for an identified hardware device comprising:
a network-aware virtual hardware bus driver, the network-aware virtual hardware bus driver is software interfaced to the local plug and play installer,
a network access point device, the network access point device further includes a hardware bus driver, the hardware bus driver further includes a remote plug-and-play trigger, wherein the remote plug-and-play trigger is capable of communicating with the network-aware virtual hardware bus driver through the networked environment,
wherein the remote plug-and-play trigger is invoked, the remote plug-and-play trigger transmits the identity of the attached hardware device to the network-aware virtual hardware bus driver, wherein the network-aware virtual hardware bus driver invokes the local plug and play installer with the identify of the attached hardware device wherein the network-aware virtual hardware bus driver installs a software driver appropriate for the attached hardware device.

2. The system of claim 1 wherein the network-aware virtual hardware bus driver invokes the remote plug-and-play trigger.

3. The system of claim 2 wherein the client computer further includes a web browser, wherein the network-aware virtual hardware bus driver uses the web browser to invoke the remote plug-and-play trigger.

4. The system of claim 3 wherein the network-aware virtual hardware further includes a web server wherein the identity of the hardware device is communicated to the network-aware virtual hardware bus driver by a response from the web server to the web browser.

5. The system of claim 4 wherein the response from the web server to the web browser includes an executable file capable of installing the software driver for the attached hardware device when executed on the client computer.

6. The system of claim 5 wherein the response from the web server to the web browser further includes data appended to the executable file.

7. The system of claim 6 wherein the appended data includes the identity of the attached hardware device and the network address of the network access point device.

8. The system of claim 1 wherein the client computer further includes a web browser, wherein the network-aware virtual hardware bus driver uses the web browser to invoke the remote plug-and-play trigger.

9. The system of claim 8 wherein the network-aware virtual hardware further includes a web server wherein the identity of the hardware device is communicated to the network-aware virtual hardware bus driver by a response from the web server to the web browser.

10. The system of claim 9 wherein the response from the web server to the web browser includes an executable file capable of installing the software driver for the attached hardware device when executed on the client computer.

11. The system of claim 10 wherein the response from the web server to the web browser further includes data appended to the executable file.

12. The system of claim 11 wherein the appended data includes the identity of the attached hardware device and the network address of the network access point device.

13. A method for installing a software driver for a hardware device in a client computer in a networked environment, wherein the client computer is interfaced to the networked environment, the client computer further includes an operating system, the operating system further includes a local plug-and-play installer capable of installing software drivers for an identified hardware device comprising the steps of:
associating a network-aware virtual hardware bus driver with the network-aware virtual hardware bus driver, the network-aware virtual hardware bus driver is software interfaced to the local plug and play installer,
associating a network access point device with the network access point device, the network access point device further includes a hardware bus driver, the hardware bus driver further includes a remote plug-and-play trigger, wherein the remote plug-and-play trigger is capable of communicating with the network-aware virtual hardware bus driver through the networked environment,
wherein the remote plug-and-play trigger is invoked, the remote plug-and-play trigger transmits the identity of the attached hardware device to the network-aware virtual hardware bus driver, wherein the network-aware virtual hardware bus driver invokes the local plug and play installer with the identify of the attached hardware device wherein the network-aware virtual hardware bus driver installs a software driver appropriate for the attached hardware device.

14. The method of claim 13 wherein the network-aware virtual hardware bus driver invokes the remote plug-and-play trigger.

15. The method of claim 14 wherein the client computer further includes a web browser, wherein the network-aware virtual hardware bus driver uses the web browser to invoke the remote plug-and-play trigger.

16. The method of claim 15 wherein the network-aware virtual hardware further includes a web server wherein the identity of the hardware device is communicated to the network-aware virtual hardware bus driver by a response from the web server to the web browser.

17. The method of claim 16 wherein the response from the web server to the web browser includes an executable file capable of installing the software driver for the attached hardware device when executed on the client computer.

18. The method of claim 17 wherein the response from the web server to the web browser further includes data appended to the executable file.

19. The method of claim 18 wherein the appended data includes the identity of the attached hardware device and the network address of the network access point device.

20. The method of claim 13 wherein the client computer further includes a web browser, wherein the network-aware virtual hardware bus driver uses the web browser to invoke the remote plug-and-play trigger.

21. The method of claim 20 wherein the network-aware virtual hardware further includes a web server wherein the identity of the hardware device is communicated to the network-aware virtual hardware bus driver by a response from the web server to the web browser.

22. The method of claim 21 wherein the response from the web server to the web browser includes an executable file capable of installing the software driver for the attached hardware device when executed on the client computer.

23. The method of claim 22 wherein the response from the web server to the web browser further includes data appended to the executable file.

24. The method of claim 23 wherein the appended data includes the identity of the attached hardware device and the network address of the network access point device.
